(19) United States
(12) Patent Application Publication
(10) Pub. No.: US 2017/0158185 A1
(43) Pub. Date: Jun. 8, 2017

(54) METHOD AND APPARATUS FOR CONTROLLING STARTING OF LIQUEFIED PETROLEUM INJECTION ENGINE OF MILD HYBRID ELECTRIC VEHICLE

(71) Applicant: HYUNDAI MOTOR COMPANY, Seoul (KR)

(72) Inventors: Hyun KIM, Hwaseong-si (KR); Ki Hong KANG, Gwangmyeong-si (KR); Sung Il YOU, Gwacheon-si (KR); Hwa Yong JANG, Hwaseong-si (KR); Yong Ug KIM, Anyang-si (KR); YoungMin KIM, Yongin-si (KR)

(21) Appl. No.: 15/263,750

(22) Filed: Sep. 13, 2016

(30) Foreign Application Priority Data
Dec. 8, 2015 (KR) 10-2015-0174032

(51) Int. Cl. B60W 10/08; B60W 30/18; B60W 10/30; F02D 41/26; F02P 15/00

(52) U.S. Cl. CPC B60W 10/08; F02D 41/26; F02P 15/001; F02P 15/006; B60W 10/30; B60W 30/18054; B60W 2510/0614; B60W 2710/30; B60Y 2400/433; B60Y 2400/47; B60Y 2300/43; B60Y 2300/1805; B60Y 2300/63; B60Y 2300/69; B60K 25/02

(57) ABSTRACT

A method for controlling starting of a Liquefied Petroleum Injection (LPI) engine of a mild hybrid electric vehicle includes driving a fuel pump when a first node of an ignition switch is selected, performing an engine cranking operation by driving a Mild Hybrid Starter & Generator (MHSG) when a second node of the ignition switch is selected, determining whether a cranking completion condition is satisfied while performing the engine cranking operation, comparing a pressure of a Liquefied Petroleum Gas (LPG) fuel with a target pressure, and controlling the MHSG to generate a torque corresponding to an idle torque of the LPI engine when the pressure of the LPG fuel is less than the target pressure.

### CROSS-REFERENCE TO RELATED APPLICATION

This application claims the benefit of priority to Korean Patent Application No. 10-2015-0174032, filed with the Korean Intellectual Property Office on Dec. 8, 2015, the entire contents of which are incorporated herein by reference.

### TECHNICAL FIELD

The present disclosure relates to a mild hybrid electric vehicle. More particularly, the present disclosure relates to a method and an apparatus for controlling starting of a Liquefied Petroleum Injection (LPI) engine of a mild hybrid electric vehicle.

### BACKGROUND

As is generally known in the art, a hybrid electric vehicle may use an internal combustion engine and a battery power source together. The hybrid electric vehicle efficiently combines torque of the internal combustion engine and torque of a motor.

Hybrid electric vehicles may be divided into a hard type and a mild type according to a power sharing ratio between an engine and a motor. In the case of the mild type of hybrid electric vehicle (hereinafter referred to as a mild hybrid electric vehicle), an integrated starter & generator (ISG) configured to start the engine or generate electricity according to an output of the engine is used instead of an alternator. In the case of the hard type of hybrid electric vehicle, a driving motor for generating driving torque is used in addition to the ISG. The integrated starter & generator may refer to a hybrid starter & generator (HSG).

The mild hybrid electric vehicle does not provide a driving mode in which torque of the ISG is used as the main driving torque, but the ISG may assist torque of the engine according to running states of the vehicle and may charge a battery through regenerative braking. Accordingly, energy efficiency of the mild hybrid electric vehicle may be improved.

In a case of a mild hybrid electric vehicle to which an LPI engine is applied, in order to inject a liquefied petroleum gas (LPG) fuel in a liquid state, a pressure of the LPG fuel needs to be greater than a predetermined pressure.

If the LPI engine is started in a state in which the pressure of the LPG fuel is low, the starting may be delayed and malfunctions of the LPI engine may occur. Accordingly, in the case of the conventional vehicle to which the LPI engine is applied, an LPI lamp indicating whether the starting is possible in an instrument panel is turned on when an ON mode of an ignition switch is selected. After that, when the pressure of the LPG fuel reaches the predetermined pressure, the LPI lamp is turned off to inform a driver that the LPI engine is ready to be started. Approximately 3 to 10 seconds is required from when the LPI lamp is turned on to when the LPI lamp is turned off.

However, the driver often disregards the indication of the LPI lamp and a START mode of the ignition switch is selected before the LPI lamp is turned off. As a result, the driver feels that starting of the LPI engine is delayed.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide a method and an apparatus for controlling starting of a Liquefied Petroleum Injection (LPI) engine of a mild hybrid electric vehicle having advantages of starting the LPI engine by controlling a Mild Hybrid Starter & Generator (MHSG) before a pressure of a Liquefied Petroleum Gas (LPG) fuel reaches a target pressure.

A method for controlling starting of an LPI engine of a mild hybrid electric vehicle according to an exemplary embodiment of the present disclosure may include: driving a fuel pump when a first node of the ignition switch is selected; performing an engine cranking operation by driving an MHSG when a second node of the ignition switch is selected; determining whether a cranking completion condition is satisfied while performing the engine cranking operation; comparing a pressure of an LPG fuel with a target pressure; and controlling the MHSG to generate a torque corresponding to an idle torque of the LPI engine when the pressure of the LPG fuel is less than the target pressure.

The performing of the engine cranking operation may include: maintaining a maximum torque of the MHSG to increase a speed of the LPI engine.

The method may further include generating the idle torque of the LPI engine using combustion of the LPG fuel when the pressure of the LPG fuel is greater than or equal to the target pressure.

The generating of the idle torque of the LPI engine using the combustion of the LPG fuel may include decreasing a torque of the MHSG.

The cranking completion condition may be satisfied when a speed of the LPI engine is greater than a target speed.

An apparatus for controlling a starting of an LPI engine of a mild hybrid electric vehicle according to an exemplary embodiment of the present disclosure may include: an ignition switch including a first node and a second node; a pressure sensor for measuring a pressure of an LPG fuel; an engine speed sensor for measuring a speed of the LPI engine; a controller connected to the ignition switch, the pressure sensor, and the engine speed sensor, and for controlling starting of the LPI engine; a MHSG for starting the LPI engine or generating electricity according to an output of the LPI engine; and a fuel pump for pumping the LPG fuel, wherein the controller may drive the fuel pump when the first node of the ignition switch is selected, may perform an engine cranking operation by driving the MHSG when the second node of the ignition switch is selected, may determine whether a cranking completion condition is satisfied while performing the engine cranking operation, may compare a pressure of the LPG fuel with a target pressure when the engine cranking completion condition is satisfied, and may control the MHSG to generate a torque corresponding to an idle torque of the LPI engine when the pressure of the LPG fuel is less than the target pressure.

The controller may maintain a maximum torque of the MHSG to increase a speed of the LPI engine while performing the engine cranking operation.

The controller may generate the idle torque of the LPI engine using combustion of the LPG fuel when the pressure off the LPG fuel is greater than or equal to the target pressure.

The controller may decrease a torque of the MHSG when the pressure of the LPG fuel is greater than or equal to the target pressure.

The cranking completion condition may be satisfied when a speed of the LPI engine is greater than a target speed.

According to an exemplary embodiment of the present disclosure, the LPI engine may be started by controlling the MHSG before the pressure of the LPG fuel reaches the target pressure. In addition, the LPI lamp indicating whether the starting of the LPI engine is possible according to the conventional art is not required.

### BRIEF DESCRIPTION OF THE DRAWINGS

FIG. 1 is a schematic diagram of a mild hybrid electric vehicle according to an exemplary embodiment of the present disclosure.

FIG. 2 is a diagram of a fuel supply system of an LPI engine according to an exemplary embodiment of the present disclosure.

FIG. 3 is a flowchart of a method for controlling a starting of an LPI engine according to an exemplary embodiment of the present disclosure.

### DETAILED DESCRIPTION OF THE EMBODIMENTS

In the following detailed description, the present disclosure will be described more fully with reference to the accompanying drawings, in which exemplary embodiments of the disclosure are shown. However, the present disclosure is not limited to the exemplary embodiments which are described herein, and may be modified in various different ways.

Parts which are not related with the description are omitted for clearly describing the exemplary embodiment of the present disclosure, and like reference numerals refer to like or similar elements throughout the specification.

Since each component shown in the drawings is illustrated for easy description, the present disclosure is not particularly limited to the components illustrated in the drawings.

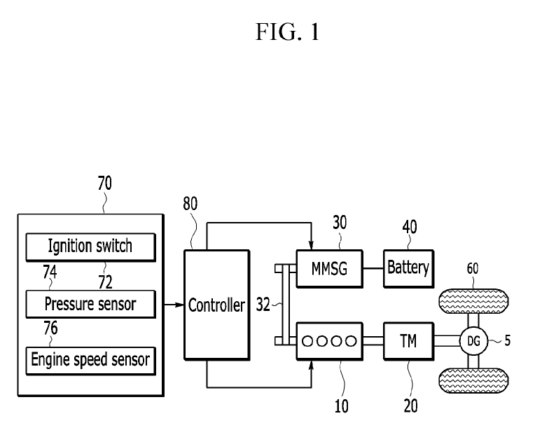

FIG. 1 is a schematic diagram of a mild hybrid electric vehicle according to an exemplary embodiment of the present disclosure.

As shown in FIG. 1, a mild hybrid electric vehicle according to an exemplary embodiment of the present disclosure may include a liquefied petroleum injection (LPI) engine 10, a transmission 20, a mild hybrid starter & generator (MHSG) 30, a battery 40, a differential gear apparatus 50, a wheel 60, a data detector 70 and a controller 80.

In connection with torque transmission of the mild hybrid electric vehicle, torque generated from the LPI engine 10 may be transmitted to an input shaft of the transmission 20, and torque output from an output shaft of the transmission 20 may be transmitted to an axle via the differential gear apparatus 50. The axle rotates the wheel 60 such that the mild hybrid electric vehicle runs by the torque generated from the LPI engine 10.

The MHSG 30 starts the LPI engine 10 or generates electricity according to an output of the LPI engine 10. In addition, the MHSG 30 may assist torque of the LPI engine 10. In other words, torque of the LPI engine 10 is used as main torque and torque of the MHSG 30 is used as auxiliary torque. The LPI engine 10 and the MHSG 30 may be connected to each other through a belt 32.

The battery 40 may supply electricity to the MHSG 30, and may be charged through electricity recovered through the MHSG 30 in a regenerative braking mode. The battery 40 may be a 48 V battery. The mild hybrid electric vehicle may further include a low voltage DC-DC converter (LDC) converting a voltage supplied from the battery 40 into a low voltage and a 12 V battery supplying a low voltage to electrical loads (e.g., a headlamp, an air conditioner, and a wiper).

The data detector 70 may detect data for controlling a starting control of the LPI engine 10, and the data detected by the data detector 70 may be transmitted to the controller 80. The data detector 70 may include an ignition switch 72, a pressure sensor 74 and an engine speed sensor 76.

The ignition switch 72 may include a plurality of nodes. The plurality of nodes may include an OFF node, an ACC node, an ON node (hereinafter referred to as a first node), and a START node (hereinafter referred to as a second node). When the OFF node is selected, the LPI engine 10 may be stopped. When the ACC node is selected, an accessory such as a radio device may be used. When the first node is selected, electronic devices using the voltage of the battery 40 may be used. When the second node is selected, the LPI engine 10 may be started by the MHSG 30. The nodes of the ignition switch 72 may be selected by a starting key or a starting button.

The pressure sensor 74 may measure a pressure of liquefied petroleum gas (LPG) fuel and transmit a signal corresponding thereto to the controller 80.

The engine speed sensor 76 may measure a speed of the LPI engine 10 and transmit a signal corresponding thereto to the controller 80.

The controller 80 may be electrically connected to the data detector 70. The controller 80 may be implemented with one or more processors executed by a predetermined program. The predetermined program may include a series of commands for performing each step included in a method for controlling starting of an LPI engine according to an exemplary embodiment of the present disclosure.

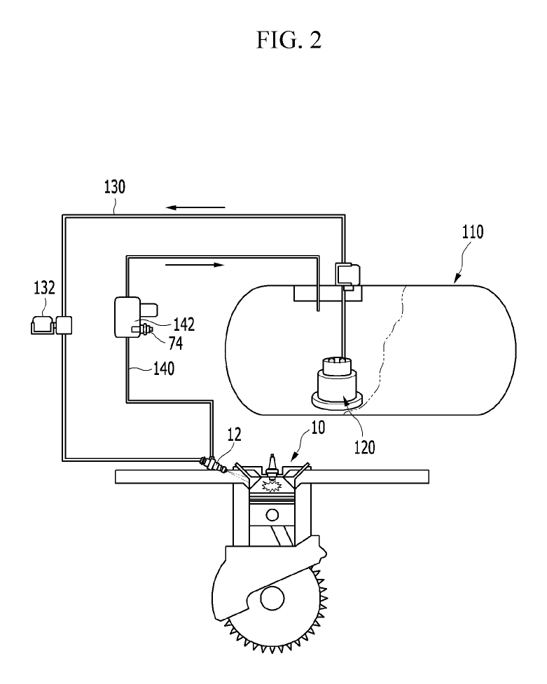

FIG. 2 is a diagram of a fuel supply system of an LPI engine according to an exemplary embodiment of the present disclosure.

As shown in FIG. 2, a fuel supply system of an LPI engine according to an exemplary embodiment of the present disclosure may include a bombe 110, a fuel pump 120, an injector 12, a fuel supply line 130 and a fuel return line 140.

The bombe 110 may store liquefied petroleum gas (LPG) fuel.

The fuel pump 120 pumps the LPG fuel so as to supply the LPG fuel to the LPI engine 10. The fuel pump 120 may be mounted in the bombe 110 and may pump the LPG fuel filled in the bombe 110.

The injector 12 may be disposed at the LPI engine 10 and inject the LPG fuel into a combustion chamber of the LPI engine 10.

The fuel supply line 130 may connect the fuel pump 120 to the injector 12 so as to supply the LPG fuel.

A cut-off valve 132 may be mounted on the fuel supply line 130. When the LPI engine 10 is stopped, the fuel supply may be cut off by the cut-off valve 132.

One end of the fuel return line 140 may be connected to the LPI engine 10 and the other end may be connected to the bombe 110. Residual fuel that is not used in a combustion process may be returned to the bombe 110 through the fuel return line 140.

The pressure sensor 74 and a pressure regulator 142 may be mounted on the fuel return line 140. The pressure sensor 74 may measure a pressure of the LPG fuel and transmit a signal corresponding thereto to the controller 80. The pressure of the LPG fuel may be maintained within a predetermined range by the pressure regulator 142.

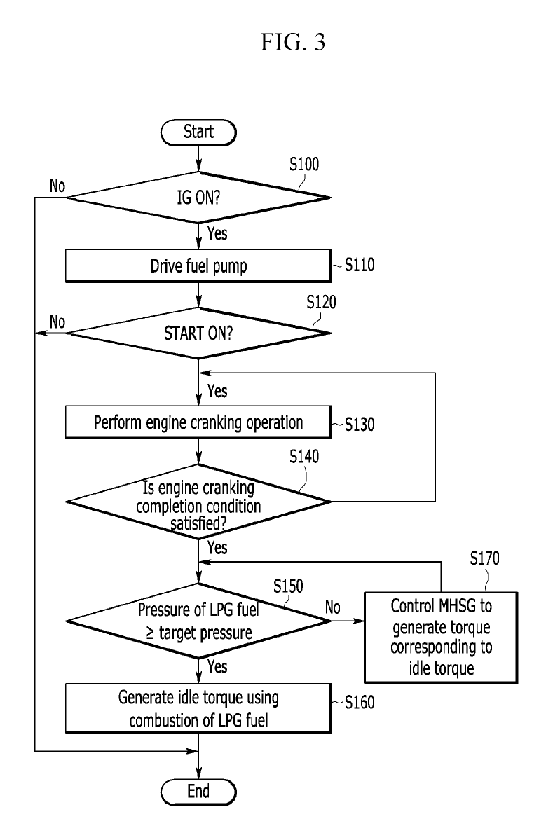

Hereinafter, a method for controlling starting of an LPI engine according to an exemplary embodiment of the present disclosure will be described in detail with reference to FIG. 3.

FIG. 3 is a flowchart of a method for controlling starting of an LPI engine according to an exemplary embodiment of the present disclosure.

As shown in FIG. 3, the controller 80 may determine whether the first node of the ignition switch 72 is selected at step S100. The first node may be the ON node of the ignition switch 72.

When the first node of the ignition switch 72 is not selected at step S100, the controller 80 may finish the method for controlling the starting of the LPI engine according to an exemplary embodiment of the present disclosure.

When the first node of the ignition switch 72 is selected at step S100, the controller 80 may drive the fuel pump 120 at step S110. In this case, the controller 80 may control the fuel pump 120 so as to maximize the speed of the fuel pump 120 until the pressure of the LPG fuel reaches a target pressure. The target pressure may be set to a value in consideration of a pressure where the LPG fuel enters a liquid state. When the pressure of the LPG fuel reaches the target pressure, the controller 80 may decrease the speed of the fuel pump 120 to maintain the speed of the fuel pump 120 in a predetermined range.

While driving the fuel pump 120, the controller 80 may determine whether the second node of the ignition switch 72 is selected at step S120. The second node may be the START node of the ignition switch 72.

When the second node of the ignition switch 72 is not selected at step S120, the controller 80 may finish the method for controlling the starting of the LPI engine according to an exemplary embodiment of the present disclosure.

When the second node of the ignition switch 72 is selected at step S120, the controller 80 may perform an engine cranking operation by driving the MHSG 30 at step S130. In this case, the controller 80 may maintain maximum torque of the MHSG 30 to increase the speed of the LPI engine 10.

While performing the engine cranking operation, the controller 80 may determine whether a cranking completion condition is satisfied at step S140. The cranking completion condition may be satisfied when the speed of the LPI engine 10 is greater than a target speed. The target speed may be set to a value in consideration of types of the LPI engine 10.

When the cranking completion condition is not satisfied at step S140, the controller 80 may continuously maintain the maximum torque of the MHSG 30.

When the cranking completion condition is satisfied at step S140, the controller 80 may compare the pressure of the LPG fuel with the target pressure at step S150.

When the pressure of the LPG fuel is greater than or equal to the target pressure at step S150, the controller 80 may generate an idle torque of the LPI engine 10 using combustion of the LPG fuel at step S160. In other words, the controller 80 may control the injector 12 to inject the LPG fuel in the liquid state, thereby generating the idle torque of the LPI engine 10. In this case, the controller 80 may decrease the torque of the MHSG 30.

When the pressure of the LPG fuel is less than the target pressure at step S150, the controller 80 may control the MHSG 30 to generate a torque corresponding to the idle torque of the LPI engine 10 at step S170. In this case, since the LPG fuel is in a gas-liquid state, the controller 80 may control the injector 12 to not inject the LPG fuel. After that, the controller 80 may return to step S150. In other words, the controller 80 may generate the torque corresponding to the idle torque of the LPI engine 10 by controlling the MHSG 30 until the pressure of the LPG fuel reaches the target pressure.

As described above, according to an exemplary embodiment of the present disclosure, the LPI engine 10 may be started by controlling the MHSG 30 before the pressure of the LPG fuel reaches the target pressure. In addition, the LPI lamp indicating whether the starting of the LPI engine is possible according to the conventional art is not required, increasing the quality of a user's experience.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method for controlling starting of a Liquefied Petroleum Injection (LPI) engine of a mild hybrid electric vehicle, comprising:
driving a fuel pump when a first node of an ignition switch is selected;
performing an engine cranking operation by driving a Mild Hybrid Starter & Generator (MHSG) when a second node of the ignition switch is selected;
determining whether a cranking completion condition is satisfied while performing the engine cranking operation;
comparing a pressure of a Liquefied Petroleum Gas (LPG) fuel with a target pressure; and
controlling the MHSG to generate a torque corresponding to an idle torque of the LPI engine when the pressure of the LPG fuel is less than the target pressure.

2. The method of claim 1, wherein the step of performing the engine cranking operation comprises maintaining a maximum torque of the MHSG to increase a speed of the LPI engine.

3. The method of claim 1, further comprising generating the idle torque of the LPI engine using combustion of the LPG fuel when the pressure of the LPG fuel is greater than or equal to the target pressure.

4. The method of claim 3, wherein the step of generating the idle torque of the LPI engine using the combustion of the LPG fuel comprises decreasing a torque of the MHSG.

5. The method of claim 1, wherein the cranking completion condition is satisfied when a speed of the LPI engine is greater than a target speed.

6. An apparatus for controlling starting of a Liquefied Petroleum Injection (LPI) engine of a mild hybrid electric vehicle, comprising:
an ignition switch including a first node and a second node;
a pressure sensor for measuring a pressure of a liquefied petroleum gas (LPG) fuel;
an engine speed sensor for measuring a speed of the LPI engine;
a controller connected to the ignition switch, the pressure sensor, and the engine speed sensor, and for controlling the starting the LPI engine;
a mild hybrid starter & generator (MHSG) for starting the LPI engine or generating electricity according to an output of the LPI engine; and
a fuel pump for pumping the LPG fuel,
wherein the controller drives the fuel pump when the first node of the ignition switch is selected, performs an engine cranking operation by driving the MHSG when the second node of the ignition switch is selected, determines whether a cranking completion condition is satisfied while performing the engine cranking operation, compares a pressure of the LPG fuel with a target pressure when the engine cranking completion condition is satisfied, and controls the MHSG to generate a torque corresponding to an idle torque of the LPI engine when the pressure of the LPG fuel is less than the target pressure.

7. The apparatus of claim 6, wherein the controller maintains a maximum torque of the MHSG to increase a speed of the LPI engine while performing the engine cranking operation.

8. The apparatus of claim 6, wherein the controller generates the idle torque of the LPI engine using combustion of the LPG fuel when the pressure off the LPG fuel is greater than or equal to the target pressure.

9. The apparatus of claim 8, wherein the controller decreases a torque of the MHSG when the pressure of the LPG fuel is greater than or equal to the target pressure.

10. The apparatus of claim 6, wherein the cranking completion condition is satisfied when a speed of the LPI engine is greater than a target speed.
